(19) United States
(12) Patent Application Publication
(10) Pub. No.: US 2012/0003409 A1
(43) Pub. Date: Jan. 5, 2012

(54) Pneumatic Object Provided with Gas-Tight Layer Comprising Two Thermoplastic Elastomers

(75) Inventors: Pierre Lesage, Clemont-Ferrand (FR); Vincent Abad, Chamalieres (FR); Cécile Barbier, Saint Bonnet Pres Riom (FR); Emmanuel Custodero, Chamalieres (FR)

(73) Assignees: Michelin Recherche et Technique S.A., Granges-Paccot (CH); SOCIETE DE TECHNOLOGIE MICHELIN, Clermont-Ferrand (FR)

(21) Appl. No.: 13/132,793

(22) PCT Filed: Nov. 30, 2009
(86) PCT No.: PCT/EP2009/008502

§ 371 Date: Sep. 21, 2011

(30) Foreign Application Priority Data
Dec. 3, 2008 (FR) 0858240

(51) Int. Cl. B32B 1/08; B60C 5/14

(52) U.S. Cl. 428/35.7; 152/510; 152/511

(57) ABSTRACT

Inflatable article equipped with an elastomer layer impermeable to the inflation gases comprising at least: as first thermoplastic stirene elastomer, at least 50 phr of a copolymer containing polystirene and polyisobutylene blocks, in particular SIBS; as second thermoplastic stirene elastomer, at most 50 phr of a thermoplastic stirene copolymer of unsaturated type, in particular SIS; and optionally an extender oil, in particular polybutene, at a content preferably between 5 and 100 phr. This gastight elastomer layer has very good impermeability properties and a lower hysteresis compared to layers based on butyl rubber. The inflatable article can be, in particular, an inner tube or a pneumatic tire for a motor vehicle.

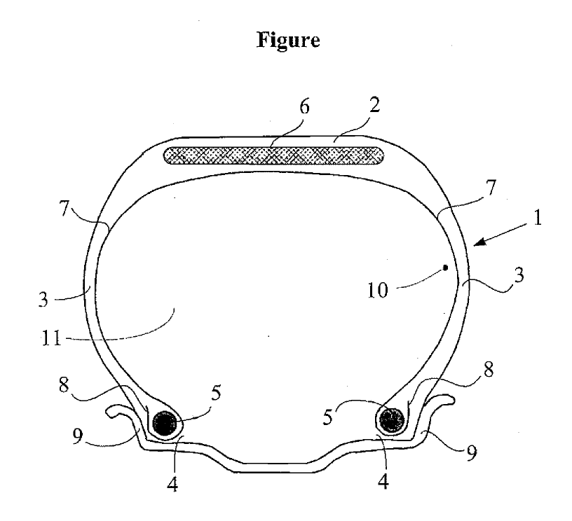

The present invention relates to “inflatable” articles, that is to say, by definition, to articles that assume their useable shape when they are inflated with air or with an equivalent inflation gas.

It relates more particularly to the gastight layers that ensure the impermeability of these inflatable articles, in particular that of pneumatic tires.

In a conventional pneumatic tire of the “tubeless” type (that is to say of the type without an inner tube), the radially internal face comprises an airtight layer (or more generally a layer that is impermeable to any inflation gas) which enables the pneumatic tire to be inflated and kept under pressure. Its impermeability properties enable it to guarantee a relatively low rate of pressure loss, making it possible to keep the tire inflated, in the normal operating state, for a sufficient time, normally several weeks or several months. It also has the role of protecting the carcass reinforcement from the diffusion of air coming from the internal space of the tire.

This role of gastight inner layer or “inner liner” is today fulfilled by compositions based on butyl rubber (isobutylene/isoprene copolymer), long renowned for their excellent impermeability properties.

However, one well-known drawback of compositions based on butyl rubber or elastomer is that they have high hysteresis losses, furthermore over a wide temperature range, which drawback degrades the rolling resistance of pneumatic tires.

Reducing the hysteresis of these impermeable inner layers and therefore, in fine, the fuel consumption of motor vehicles, is a general objective which current technology comes up against.

However, the Applicants discovered, during their research, that an elastomer layer other than a butyl layer makes it possible to obtain impermeable inner layers that respond to such an objective, while affording the latter excellent impermeability properties.

Thus, according to a first subject, the present invention relates to an inflatable article equipped with an elastomer layer impermeable to inflation gases, characterized in that said elastomer layer comprises at least:
as a first thermoplastic stirene elastomer, at least 50 phr of a copolymer containing polystirene and polyisobutylene blocks;
as a second thermoplastic stirene elastomer, at most 50 phr of an unsaturated thermoplastic stirene elastomer.

Compared with a butyl rubber, the above stirene elastomers have the major advantage, due to their thermoplastic nature, of being able to be worked as is in the molten (liquid) state, and consequently of offering a possibility of simplified processing.

The invention particularly relates to inflatable articles made of rubber such as pneumatic tires, or inner tubes, especially inner tubes for a pneumatic tire.

The invention relates more particularly to the pneumatic tires intended to be fitted on motor vehicles of the passenger type, SUV (Sport Utility Vehicle) type, two-wheeled vehicles (especially motorcycles), aircraft, industrial vehicles such as vans, heavy vehicles (that is to say underground trains, buses, road transport vehicles such as lorries, towing vehicles, trailers, off-road vehicles, such as agricultural and civil-engineering vehicles) and other transport or handling vehicles.

The invention also relates to the use, in an inflatable article, of an elastomer layer as defined above as a layer impermeable to inflation gases.

The invention and its advantages will be easily understood in light of the description and of the exemplary embodiments that follow, and also from the single FIGURE relating to these examples which schematically shows, in radial cross section, a pneumatic tire according to the invention.

### DETAILED DESCRIPTION OF THE INVENTION

In the present description, unless otherwise indicated, all the percentages (%) indicated are % by weight.

Moreover, any range of values denoted by the expression “between a and b” represent the field of values ranging from more than a to less than b (that is to say limits a and b excluded) whereas any range of values denoted by the expression “from a to b” means the field of values ranging from a up to b (that is say including the strict limits a and b).

Finally, the term “phr” means parts by weight per hundred parts of total elastomer (or “rubber”, both terms being considered to be synonymous), i.e. of the total of the elastomers present in the elastomer composition forming the gastight layer.

### I-1. Gastight Elastomer Layer

The inflatable article according to the invention has the main feature of being equipped with a gastight layer that is formed from a thermoplastic elastomer composition, said layer or composition comprising at least:
as first thermoplastic stirene elastomer, at least 50 phr of a copolymer containing polystirene and polyisobutylene blocks;
as second thermoplastic stirene elastomer, at most 50 phr of a thermoplastic stirene elastomer of unsaturated type;
optionally other additives such as an extender oil or a platy filler.

In other words, the content of first elastomer is within a range from 50 phr to less than 100 phr and the content of second elastomer (different from the first elastomer and always present in the gastight layer) is within a range from more than 0 phr to 50 phr maximum.

The formulation of this elastomer layer is described in detail below.

### I-1-A. Thermoplastic Stirene Elastomers

It will be recalled, first of all, that thermoplastic stirene (abbreviated hereafter to “TPS”) elastomers are thermoplastic elastomers which are in the form of stirene-based block copolymers.

Having a structure intermediate between thermoplastic polymers and elastomers, they are composed, in a known manner, of hard polystirene blocks linked by flexible elastomer blocks, for example polybutadiene, polyisoprene or poly(ethylene/butylene) blocks. They are often triblock elastomers with two hard segments linked by a flexible segment. The hard and flexible segments may be in a linear, star or branched configuration. These TPS elastomers may also be diblock elastomers with one single hard segment linked to a flexible segment. Typically, each of these segments or blocks contains at least more than 5, generally more than 10 base units (for example stirene units and isoprene units for a stirene/isoprene/stirene block copolymer).

As a reminder, the term “copolymer containing polystirene and polyisobutylene blocks” should be understood, in the present application, as meaning any thermoplastic stirene copolymer comprising at least one polystirene block (that is say one or more polystirene blocks) and at least one polyisobutylene block (that is to say one or more polyisobutylene blocks), with which other saturated or unsaturated blocks (for example polyethylene and/or polypropylene blocks) and/or other monomer units (for example unsaturated units such as diene units) may or may not be combined.

This copolymer containing polystirene and polyisobutylene blocks, also referred to as “first TPS copolymer” in the present application, is in particular chosen from the group consisting of stirene/isobutylene (abbreviated to “SIB”) diblock copolymers, stirene/isobutylene/stirene (abbreviated to “SIBS”) triblock copolymers and blends of these, by definition completely saturated, SIB and SIBS copolymers. The invention also applies to the case in which the polyisobutylene block, in the above copolymers, can be interrupted by one or more unsaturated units, in particular one or more diene units such as isoprene units, which are optionally halogenated.

It was observed that the presence of this first TPS, especially SIB or SIBS, copolymer affords the elastomer layer excellent impermeability properties while significantly reducing the hysteresis compared to conventional layers based on butyl rubber.

Regarding the second thermoplastic stirene elastomer (also referred to as “second TPS copolymer”), it will firstly be recalled that, in a manner well known to a person skilled in the art, that the expression “unsaturated TPS elastomer” should be understood to mean a TPS elastomer that is provided with ethylenically unsaturated groups, that is to say which comprises (conjugated or unconjugated) carbon-carbon double bonds. The expression “saturated TPS elastomer” should be understood to mean a TPS elastomer that does not comprise any ethylenically unsaturated groups, i.e. no carbon-carbon double bonds.

According to one preferred variant, the second TPS copolymer is a copolymer that comprises stirene blocks and diene blocks, these diene blocks being in particular isoprene or butadiene blocks. More preferably, this unsaturated second TPS copolymer is chosen from the group consisting of stirene/butadiene (SB), stirene/isoprene (SI), stirene/butadiene/butylene (SBB), stirene/butadiene/isoprene (SBI), stirene/butadiene/stirene (SBS), stirene/butadiene/butylene/stirene (SBBS), stirene/isoprene/stirene (SIS) and stirene/butadiene/isoprene/stirene (SBIS) block copolymers and blends of these copolymers.

It was observed that the presence of this unsaturated second TPS copolymer, in the gastight layer, makes it possible to greatly improve the adhesion of the latter to another unsaturated polymer layer, present for example in the inflatable article of the invention. By way of example, such another unsaturated polymer layer is a diene elastomer composition, in particular based on natural rubber, such as those that are commonly used for the carcass reinforcements of pneumatic tires, generally and in a known manner, in direct contact with the sealing inner layer of such pneumatic tires.

According to one preferred embodiment of the invention, the weight, content of stirene in each (first and second) TPS copolymer is between 5% and 50%. Below the minimum indicated, the thermoplastic nature of the elastomers runs the risk of being substantially reduced, whereas above the recommended maximum the elasticity of the gastight layer may be adversely affected. For these reasons, the stirene content is more preferably between 10% and 40%, in particular between 15 and 35%.

The term “stirene” should be understood in the present description as meaning any monomer based on unsubstituted or substituted stirene; among the substituted stirenes mention may be made, for example, of methylstirenes (for example, α-methylstirene, β-methylstirene, p-methylstirene, tert-butylstirene), chlorostirenes (for example monochlorostirene, dichlorostirene).

It is preferable for the T_{g} (glass transition temperature, measured according to ASTM D3418) of each (first and second) TPS copolymer to be below −20° C., in particular below −40° C. A T_{g} value above these minimum temperatures may reduce the performance of the airtight layer when used at a very low temperature; for such a use, the T_{g} of the TPS copolymers is more preferably still below −50° C.

The number-average molecular weight (denoted by Mₙ) of the first TPS copolymer is preferably between 30 000 and 500 000 g/mol, more preferably between 40 000 and 400 000 g/mol. Below the minimum values indicated, the cohesion between the elastomer block chains especially due to the optional dilution thereof via an extender oil, runs the risk of being adversely affected. Moreover, too high a molecular weight Mₙ may be detrimental as regards the flexibility of the gastight layer. Thus, it has been observed that a value lying within a range of 50 000 to 300 000 g/mol was particularly suitable, especially for use of the composition in a pneumatic tire.

As regards the number-average molecular weight of the second TPS copolymer, it may be lower compared to the first TPS elastomer, considering the different function and generally smaller proportion of this second copolymer in the gastight composition; preferably, it is between 3 000 and 500 000 g/mol, in particular between 4 000 and 400 000 g/mol.

The number-average molecular weight (Mₙ) of the TPS elastomer is determined in a known manner by size exclusion chromatography (SEC). The specimen is first dissolved in tetrahydrofuran with a concentration of about 1 g/l; then the solution is filtered on a filter of 0.45 μm porosity before injection. The apparatus used is a WATERS Alliance chromatograph. The elution solvent is tetrahydrofuran, the flow rate is 0.7 ml/min, the temperature of the system is 35° C. and the analysis time is 90 min. A set of four WATERS columns in series having the trade names STYRAGEL (HMW7, HMW6E and two HT6E) is used. The injected volume of the polymer specimen solution is 100 μl. The detector is a WATERS 2410 differential refractometer and its associated software for handling the chromatographic data is the WATERS MILLENNIUM system. The calculated average molecular weights are relative to a calibration curve obtained with polystirene standards.

The polydispersity index Iₚ (N.B: Iₚ=M_{w}/Mₙ where M_{w} is the weight-average molecular weight) of the TPS copolymers is preferably less than 3, more preferably Iₚ is less than 2.

According to one preferred embodiment, the content of first TPS copolymer is at least 70 phr, that is to say within a range from 70 phr minimum to less than 100 phr.

According to another preferred embodiment, the content of second TPS copolymer is at most 30 phr, that is to say within a range from more than 0 phr to 30 phr maximum.

The minimum amount of (unsaturated) second TPS copolymer may be relatively small while at the same time producing the targeted technical effect (improved adhesion to another unsaturated polymer layer). Typically, the recommended amount of second TPS copolymer is at least 1 phr (in particular within a range from 1 to 30 phr), more particularly from at least 2 phr (in particular within a range from 2 to 25 phr).

Thus, according to another particularly preferred embodiment, the amount of first TPS copolymer may be within a range from 70 to 99 phr, in particular within a range from 75 to 98 phr.

The gastight layer described above could comprise elastomers other than the two TPS copolymers described previously. Such additional elastomers, which are the minority by weight compared to the first TPS copolymer, could be for example diene elastomers such as natural rubber or a synthetic polyisoprene, a butyl rubber or even other saturated thermoplastic stirene elastomers, within the limit of the compatibility of their microstructures.

As examples of other saturated thermoplastic stirene elastomers, mention may especially be made of stirene/ethylene/butylene (SEB), stirene/ethylene/propylene (SEP), stirene/ethylene/ethylene/propylene (SEEP), stirene/ethylene/butylene/stirene (SEBS), stirene/ethylene/propylene/stirene (SEPS) and stirene/ethylene/ethylene/propylene/stirene (SEEPS) block copolymers.

However, according to one preferred embodiment, the first and second TPS copolymers described above are the sole thermoplastic elastomers, and more generally the sole elastomers present in the gastight elastomer layer.

These elastomers may be processed in a conventional manner for TPEs, by extrusion or moulding, for example starting from a raw material available in the form of beads or granules.

Unsaturated TPS elastomers that can be used as second TPS copolymer such as, for example SBS, SIS or SBBS, are well known and commercially available, for example from Kraton under the name “Kraton D” (e.g., products D1161, D1118, D1116, D1163 for examples of SIS and SBS elastomers), from Dynasol under the name “Calprene” (e.g., products C405, C411, C412 for examples of SBS elastomers) or else from Asahi under the name “Tuftec” (e.g., product P1500 for an example of an SBBS elastomer).

Copolymers containing polystirene and polyisobutylene blocks that can be used as first TPS copolymer such as, for example SIBS or SIB elastomers, are also available commercially, sold for example by KANEKA under the name “SIBSTAR” (e.g. “Sibstar 103T”, “Sibstar 102T”, “Sibstar 073T” or “Sibstar 072T” for the SIBSs; “Sibstar 042D” for the SIBs). They have for example been described, and also their synthesis, in patent documents EP 731 112, U.S. Pat. No. 4,946,899 and U.S. Pat. No. 5,260,383. They were firstly developed for biomedical applications then described in various applications specific to TAE elastomers, as varied as medical equipment, motor vehicle parts or parts for electrical goods, sheaths for electrical wires, sealing or elastic parts (see, for example, EP 1 431 343, EP 1 561 783, EP 1 566 405 and WO 2005/103146).

However, to the knowledge of the Applicants no prior art document describes the use, as a gastight layer, in an inflatable article such as in particular a pneumatic tire, of an elastomer composition comprising in combination the two TPS copolymers described above, and optionally an extender oil, which composition has proved, unexpectedly, capable of competing with conventional compositions based on butyl rubber.

### I-1-B. Extender Oil

The first and second TPS copolymers described above are sufficient by themselves for the function of impermeability to gases with respect to the inflatable articles in which they are used to be fulfilled.

However, according to one particular embodiment of the invention, the gastight layer may also comprise, as a plasticizing agent, an extender oil (or plasticizing oil), the role of which is to facilitate the processing, particularly the integration into the inflatable article via a lowering of the modulus and an increase in the tackifying power of the gastight layer, albeit at the expense of a certain loss of impermeability.

This optional extender oil is preferably used at a reduced content, less than 100 phr—i.e. less than 100 parts by weight per hundred parts of total elastomer (i.e., first et second TPS copolymers above, plus additional elastomer(s) where appropriate).

Any extender oil may be used, preferably one having a weakly polar character, capable of extending or plasticizing elastomers, especially thermoplastic elastomers. At ambient temperature (23° C.), these oils, which are relatively viscous, are liquids (i.e. as a reminder, substances having the capability of eventually taking the form of their container), as opposed especially to resins which are by nature solids.

Preferably, the extender oil is chosen from the group consisting of polyolefin oils (i.e. those resulting from the polymerization of olefins, monoolefins or diolefins), paraffinic oils, naphthenic oils (of low or high viscosity), aromatic oils, mineral oils and mixtures of these oils. More preferably, the extender oil is chosen from the group consisting of polybutene oils, paraffin oils and mixtures of these oils

Very particularly, polybutene oils, polyisobutylene (PIB) oils, are used, which demonstrated the best compromise of properties compared with the other oils tested, especially compared with oils of paraffinic type.

Examples of polyisobutylene oils include those sold in particular by Univar under the trade name “Dynapak Poly” (e.g. “Dynapak Poly 190”), by BASF under the trade names “Glissopal” (e.g. “Glissopal 1000”) or “Oppanol” (e.g. “Oppanol B12”), by Ineos Oligomer under the trade name “Indopol H1200”. Paraffinic oils are sold for example by Exxon under the trade name “Telura 618” or by Repsol under the trade name “Extensol 51”.

The number-average molecular weight (Mₙ) of the extender oil is preferably between 200 and 25 000 g/mol, more preferably still between 300 and 10 000 g/mol. For excessively low Mₙ values, there is a risk of the oil migrating to the outside of the composition, whereas excessively high Mₙ values may result in this composition becoming too stiff. An Mₙ value between 350 and 4000 g/mol, in particular between 400 and 3000 g/mol, proves to be an excellent compromise for the intended applications, in particular for use in a pneumatic tire.

The number-average molecular weight (Mₙ) of the extender oil is determined by SEC, the specimen being firstly dissolved in tetrahydrofuran with a concentration of about 1 g/l and then the solution is filtered on a filter of 0.45 μm porosity before injection. The apparatus is the WATERS Alliance chromatograph. The elution solvent is tetrahydrofuran, the flow rate is 1 ml/min, the temperature of the system is 35° C. and the analysis time is 30 min. A set of two WATERS columns with the trade name “STYRAGEL HT6E” is used. The injected volume of the polymer specimen solution is 100 μl. The detector is a WATERS 2410 differential refractometer and its associated software for handling the chromatograph data is the WATERS MILLENIUM system. The calculated average molecular weights are relative to a calibration curve obtained with polystirene standards.

A person skilled in the art will know, in the light of the description and the embodiments that follow, how to adjust the quantity of extender oil according to the particular usage conditions of the gastight elastomer layer, in particular of the inflatable article in which it is intended to be used.

If an extender oil is used, it is preferable for its content to be greater than 5 phr, especially between 5 and 100 phr. Below the indicated minimum, the elastomer layer or composition runs the risk of having too high a stiffness for certain applications, whereas above the recommended maximum there is a risk of the composition having insufficient cohesion and of a loss of impermeability which may be damaging depending on the application in question.

For these reasons, in particular for use of the airtight layer in a pneumatic tire, the extender oil content is preferably greater than 10 phr, especially between 10 and 90 phr, more preferably still is greater than 20 phr, especially between 20 and 80 phr.

### I-1-C. Platy Filler

The use of a platy filler, having a volume content preferably greater than 5%, in particular between 5% and 50%, can advantageously make it possible to reduce the permeability coefficient still further (therefore to increase the impermeability) of the elastomer composition without excessively increasing its modulus, which makes it possible to retain the ease of integrating the airtight layer into the inflatable article.

Fillers referred to as platy fillers are well known to a person skilled in the art. They have been used, in particular, in pneumatic tires for reducing the permeability of conventional gastight layers based on butyl rubber. In these layers based on butyl rubber, they are generally used at relatively low contents, which do not usually exceed 10 to 15 phr (see, for example, patent documents US 2004/0194863, WO 2006/047509).

They are generally in the form of stacked plates, platelets, sheets or foliates with a relatively pronounced anisometry. Their aspect ratio (F=L/E) is generally greater than 3, more often greater than 5 or than 10. L represents the length (or larger dimension) and E the average thickness of these platy fillers, these averages being calculated by number. Aspect ratios reaching several tens or even hundreds are frequent. Their average length is preferably greater that 1 μm (that is to say that they are then platy fillers known as micron-scale platy fillers), typically between a few μm (for example 5 μm) and a few hundred μm (for example 500 or even 800 μm).

Preferably, the platy fillers used in accordance with the invention are chosen from the group consisting of graphites, phyllosilicates and mixtures of such fillers. Among the phyllosilicates, mention will especially be made of clays, talcs, micas, kaolins, these phyllosilicates possibly being modified or not for example by a surface treatment; as examples of such modified phyllosilicates, mention may especially be made of micas covered with titanium oxide, and clays modified by surfactants (“organoclays”).

Use is preferably made of platy fillers having a low surface energy, that is to say that are relatively apolar, such as those chosen from the group consisting of graphites, talcs, micas and mixtures of such fillers, the latter possibly being modified or not, more preferably still from the group composed of graphites, talcs and mixtures of such fillers. Among the graphites mention may especially be made of natural graphites, expanded graphites or synthetic graphites.

As examples of micas, mention may be made of the micas sold by CMMP (Mica-MU®, Mica-Soft®, Briomica® for example), vermiculites (especially the Shawatec® vermiculite sold by CMMP or the Microlite® vermiculite sold by W.R. Grace), modified or treated micas (for example, the Iriodin® range sold by Merck). As examples of graphites, mention may be made of the graphites sold by Timcal (Timrex® range). As examples of talcs, mention may be made of the talcs sold by Luzenac.

The platy fillers described above are preferably used at a high content, greater than 5%, more preferably at least equal to 10% by volume of elastomer composition. Such a volume content typically corresponds, taking into account the average density of the platy fillers used (typically between 2.0 and 3.0) and that of the TPS copolymers used, to a weight content preferably greater than 20 phr, more preferably at least equal to 40 phr.

In order to further increase the impermeability of the TPS elastomer layer, it is possible to use a still higher content of platy filler, at least equal to 15% or even 20% by volume, which typically corresponds to weight contents at least equal to 50 phr or even 80 phr. Weight contents greater than 100 phr are even advantageously possible.

The platy filler content is however preferably less than 50% by volume (typically less than 500 phr), the upper limit starting from which problems of increase in the modulus, embrittlement of the composition, difficulties in dispersing the filler and in processing, not to mention a possible degradation of the hysteresis, may be encountered.

It will be possible to carry out the introduction of platy fillers into the thermoplastic elastomer composition according to various known processes, for example by compounding in solution, by bulk compounding in an internal mixer, or else by compounding via extrusion.

### I-1-D. Various Additives

The airtight layer or composition described above may furthermore comprise the various additives usually present in the airtight layers known to a person skilled in the art. Mention will be made, for example, of reinforcing fillers such as carbon black or silica, non-reinforcing or inert fillers, plasticizers other than the aforementioned extender oils, protective agents such as antioxidants or antiozonants, UV stabilizers, colorants that can advantageously be used for colouring the composition, various processing aids or other stabilizers, or else promoters capable of promoting adhesion to the remainder of the structure of the inflatable article.

Besides the elastomers described previously, the gastight composition could also comprise, always in a minority weight fraction relative to the first TPS copolymer, polymers other than elastomers, such as for example thermoplastic polymers compatible with the TPS elastomers.

The gastight layer or composition described previously is a compound that is solid (at 23° C.) and elastic, which is especially characterized, thanks to its specific formulation, by a very high flexibility and very high deformability.

According to one preferred embodiment of the invention, this gastight layer or composition has a secant extension modulus, at 10% elongation, which is less than 2 MPa, more preferably less than 1.5 MPa (especially less than 1 MPa). This quantity is measured at first elongation (that is to say without an accommodation cycle) at a temperature of 23° C., with a pull rate of 500 mm/min (ASTM D412 standard), and normalized to the initial cross section of the test specimen.

### I-2. Use of the Elastomer Layer in an Inflatable Article

The elastomer layer described previously can be used as an airtight layer (or a layer that is impermeable to any other inflation gas, for example nitrogen) in any type of inflatable article. As examples of such inflatable articles, mention may be made of inflatable boats, balloons or balls used for games or sports.

Said composition is particularly suitable for use as an airtight layer in an inflatable article, whether a finished or semi-finished product, made of rubber, most particularly in a pneumatic tire for a motor vehicle such as a two-wheeled, passenger or industrial vehicle.

Such an airtight layer is preferably placed on the inner wall of the inflatable article, but it may also be completely integrated into its internal structure.

The thickness of the airtight layer is preferably greater than 0.05 mm, more preferably between 0.1 mm and 10 mm (especially between 0.1 and 1.0 mm).

It will be readily understood that, depending on the specific fields of application and on the dimensions and pressures involved, the method of implementing the invention may vary, the airtight layer then having several preferential thickness ranges.

Thus, for example, in the case of passenger vehicle tires, it may have a thickness of at least 0.3 mm, preferably between 0.5 and 2 mm. According to another example, in the case of heavy or agricultural vehicle tires, the preferred thickness may be between 1 and 3 mm. According to another example, in the case of pneumatic tires for vehicles in the civil engineering field or for aircraft, the preferred thickness may be between 2 and 10 mm.

Compared with a usual airtight layer based on butyl rubber, the airtight composition described above has the advantage of exhibiting a markedly lower hysteresis, and therefore of offering the pneumatic tires a reduced rolling resistance, as is demonstrated in the following exemplary embodiments.

### EXEMPLARY EMBODIMENTS OF THE INVENTION

The gastight elastomer layer described previously can advantageously be used in the pneumatic tires of all types of vehicles, in particular passenger vehicles or industrial vehicles such as heavy vehicles.

As an example, the single appended FIGURE shows very schematically (not drawn to scale), a radial cross section of a pneumatic tire according to the invention for a passenger vehicle.

This pneumatic tire 1 has a crown 2 reinforced by a crown reinforcement or belt 6, two sidewalls 3 and two beads 4, each of these beads 4 being reinforced with a bead wire 5. The crown 2 is surmounted by a tread (not shown in this schematic FIGURE). A carcass reinforcement 7 is wound around the two bead wires 5 in each bead 4, the upturn 8 of this reinforcement 7 lying for example towards the outside of the pneumatic tire 1, which here is shown fitted onto its rim 9. The carcass reinforcement 7 consists, as is known per se, of at least one ply reinforced by cords, called “radial” cords, for example textile or metal cords, i.e. these cords are arranged practically parallel to one another and extend from one bead to the other so as to form an angle of between 80° and 90° with the circumferential mid-plane (the plane perpendicular to the rotation axis of the pneumatic tire, which is located at mid-distance of the two beads 4 and passes through the middle of the crown reinforcement 6).

The inner wall of the pneumatic tire 1 comprises an airtight layer 10, for example having a thickness equal to around 1 mm, on the side of the internal cavity 11 of the pneumatic tire 1.

This inner layer (or “inner liner”) covers the entire inner wall of the pneumatic tire, extending from one sidewall to the other, at least as far as the rim flange when the pneumatic tire is in the fitted position. It defines the radially internal face of said pneumatic tire intended to protect the carcass reinforcement from the diffusion of air coming from the internal space 11 of the pneumatic tire. It enables the pneumatic tire to be inflated and kept under pressure. Its impermeability properties ought to enable it to guarantee a relatively low rate of pressure loss, and to make it possible to keep the pneumatic tire inflated, in the normal operating state, for a sufficient time, normally several weeks or several months.

Unlike a conventional pneumatic tire that uses a composition based on butyl rubber, the pneumatic tire according to the invention uses, as the airtight layer 10, in this example, a thermoplastic elastomer composition comprising:
as first TPS copolymer, 82 phr of an SIBS elastomer (“Sibstar 102T” with a stirene content of around 15%, a T_{g} of around −65° C. and an average molecular weight Mₙ of around 90 000 g/mol);
as second TPS copolymer, 18 phr of an SBBS elastomer (“Tuftec P1500” with a stirene content of around 37%, a Tg of around −75° C. and a weight Mₙ of around 60 000 g/mol);
as extender oil, around 55 phr of PIB oil (“Dynapak Poly 190”—Mₙ of around 1000 g/mol);
around 40 phr of a platy filler (“Iriodin 153” mica), which corresponds to a volume content of around 7.5% (% by volume of composition).

The layer 10 was prepared as follows. The mixing of the four constituents (SIBS, SBBS, PIB oil and platy filler) was carried out conventionally, using a twin-screw extruder (L/D equal to around 40), at a temperature typically above the melting temperature of the composition (around 190° C.). The extruder used comprised a feed (hopper) for each TPS copolymer (SIBS and SBBS), another feed (hopper) for the platy filler and finally a pressurized liquid injection pump for the polyisobutylene extender oil; it was provided with a die that makes it possible to extrude the product to the desired dimensions.

The pneumatic tire provided with its airtight layer (10) as described above may be produced before or after vulcanization (or curing).

In the first case (i.e., before vulcanization of the pneumatic tire), the airtight layer is simply applied in a conventional manner at the desired place, so as to form the gastight layer 10. The vulcanization is then carried out conventionally. One advantageous manufacturing variant, for a person skilled in the art of pneumatic tires, would consist for example during a first step, in laying down the airtight layer directly onto a building drum, in the form of a layer with a suitable thickness, before this is covered with the rest of the structure of the pneumatic tire, according to manufacturing techniques well known to a person skilled in the art.

In the second case (i.e. after curing of the pneumatic tire), the gastight layer is applied to the inside of the pneumatic tire cured by any appropriate means, for example by bonding, by extrusion, by spraying or else by extrusion/blow moulding a film of suitable thickness.

In the following examples, the impermeability properties were first analysed on test specimens of compositions based on butyl rubber on the one hand and on SIBS and SBBS on the other hand (with and without extender oil PIB for the second composition based on the two single TPS copolymers).

For this analysis, a rigid-wall permeameter was used, placed in an oven (temperature of 60° C. in the present case), equipped with a pressure sensor (calibrated in the range of 0 to 6 bar) and connected to a tube equipped with an inflation valve. The permeameter may receive standard test specimens in disc form (for example having a diameter of 65 mm in the present case) and with a uniform thickness which may range up to 3 mm (0.5 mm in the present case). The pressure sensor is connected to a National Instruments data acquisition card (0-10 V analogue four-channel acquisition) which is connected to a computer that carries out a continuous acquisition with a frequency of 0.5 Hz (1 point every two seconds). The permeability coefficient (K) is measured from the linear regression line (average over 1000 points) giving the slope a of the pressure loss, through the test specimen tested, as a function of the time, after a stabilization of the system, that is to say after obtaining a steady state during which the pressure decreases linearly as a function of the time.

At equivalent thickness (1 mm), it was firstly noted that the composition comprising solely the two TPS copolymers (SIBS et SBBS), that is to say with no extender oil or other additive, had a very low permeability coefficient, substantially equal to that of the standard composition based on butyl rubber. This already constitutes a remarkable result for such a composition.

As already indicated, if a certain loss of impermeability is accepted in exchange, the addition of an extender oil advantageously makes it possible to facilitate the integration of the elastomer layer into the inflatable article, via a reduction of the modulus and an increase of the tackifying power of the latter.

Thus, by using for example 55 phr of extender oil, it was observed that the permeability coefficient was increased (and therefore the impermeability reduced) by around 3 times in the presence of a conventional oil such as a paraffinic oil, whereas this coefficient was only increased by a factor of significantly less than two (1.5 times) in the presence of a PIB oil (“Dynapak Poly 190”), an increase factor that finally is not very detrimental for the use in a pneumatic tire. This is why the combination of the first and second TPS elastomers and polybutene oil such as PIB oil has proved to offer the best compromise of properties for the gastight layer. Furthermore, by adding, as indicated previously, a suitable content of platy filler (40 phr in this example), it was advantageously possible to compensate for the loss of impermeability due to the addition of an extender oil.

Moreover, adhesion tests (peel tests) were carried out in order to test the ability of the gastight layer to adhere, after curing, to a diene elastomer layer, more precisely to a standard rubber composition for a pneumatic tire carcass reinforcement, based on (peptized) natural rubber and carbon black N330 (65 parts per hundred parts of natural rubber), comprising in addition the usual additives (sulphur, accelerator, ZnO, stearic acid, antioxidant, cobalt naphthenate). It was observed that the addition of the unsaturated second TPS copolymer (for example SBBS) in the gastight layer made it possible to greatly increase, by a factor of more than two, or even more in many cases, the adhesion forces between the gaslight thermoplastic layer and the natural rubber layer.

Following the above laboratory tests, pneumatic tires according to the invention, of the passenger vehicle type (dimension 195/65 R15) were manufactured; their inner wall being covered with an airtight layer (10) having a thickness of 1 mm (on a building drum, before manufacture of the rest of the tire), then the tires were vulcanized. Said airtight layer (10) was formed from SIBS (82 phr), SBBS (18 phr), platy filler (40 phr of “Iriodin 153”), the whole thing being extended with 55 phr of PIB oil, as described above.

These pneumatic tires according to the invention were compared with control tires (Michelin “Energy 3” brand) comprising a conventional airtight layer, of the same thickness, based on butyl rubber. The rolling resistance of the pneumatic tires was measured on a flywheel, according to the ISO 8767 (1992) method.

It was observed that the pneumatic tires of the invention had a rolling resistance that was reduced very significantly, and unexpectedly for a person skilled in the art, by almost 4% relative to the control pneumatic tires.

In conclusion, the invention offers the designers of pneumatic tires the opportunity of very substantially reducing the hysteresis of the impermeable inner layers, and therefore of reducing the fuel consumption of motor vehicles fitted with such tires, without penalizing or at least without substantially penalizing the impermeability properties when using an extender oil.

1. An inflatable article equipped with an elastomer layer impermeable to inflation gases, wherein said elastomer layer comprises:
as first thermoplastic stirene elastomer, at least 50 phr of a copolymer containing polystirene and polyisobutylene blocks; and
as second thermoplastic stirene elastomer, at most 50 phr of an unsaturated thermoplastic stirene copolymer.

2. The inflatable article according to claim 1, wherein the first elastomer is chosen from the group consisting of stirene/isobutylene copolymers, stirene/isobutylene/stirene copolymers and mixtures of these copolymers.

3. The inflatable article according to claim 2, wherein the first elastomer is a stirene/isobutylene/stirene copolymer.

4. The inflatable article according to claim 1, wherein the content of first thermoplastic stirene elastomer is at least 70 phr.

5. The inflatable article according to claim 1, wherein the content of second thermoplastic stirene elastomer is at most 30 phr.

6. The inflatable article according to claim 5, wherein the content of second thermoplastic stirene elastomer is within a range from 1 to 30 phr.

7. The inflatable article according to claim 6, wherein the content of second thermoplastic stirene elastomer is within a range from 2 to 25 phr.

8. The inflatable article according to claim 1, wherein the second thermoplastic stirene elastomer is a copolymer comprising stirene blocks and diene blocks.

9. The inflatable article according to claim 8, wherein the diene blocks are isoprene or butadiene blocks.

10. The inflatable article according to claim 9, wherein the second stirene elastomer is chosen from the group consisting of stirene/butadiene (SB), stirene/isoprene (SI), stirene/butadiene/butylene (SBB), stirene/butadiene/isoprene (SBI), stirene/butadiene/stirene (SBS), stirene/butadiene/butylene/stirene (SBBS), stirene/isoprene/stirene (SIS) and stirene/butadiene/isoprene/stirene (SBIS) block copolymers and blends of these copolymers.

11. The inflatable article according to claim 1, wherein each thermoplastic stirene elastomer comprises between 5 and 50% by weight of stirene.

12. The inflatable article according to claim 1, wherein the glass transition temperature of each thermoplastic stirene elastomer is less than −20° C.

13. The inflatable article according to claim 1, wherein the number-average molecular weight of the first thermoplastic stirene elastomer is between 30 000 and 500 000 g/mol.

14. The inflatable article according to claim 1, wherein the number-average molecular weight of the second thermoplastic stirene elastomer is between 3000 and 500 000 g/mol.

15. The inflatable article according to claim 1, wherein the airtight layer comprises an extender oil.

16. The inflatable article according to claim 15, wherein the extender oil is chosen from the group consisting of polyolefin oils, paraffinic oils, naphthenic oils, aromatic oils, mineral oils, and mixtures of these oils.

17. The inflatable article according to claim 16, wherein the extender oil is chosen from the group consisting of polybutene oils.

18. The inflatable article according to claim 17, wherein the extender oil is a polyisobutylene oil.

19. The inflatable article according to claim 15, wherein the number-average molecular weight of the extender oil is between 200 and 25 000 g/mol.

20. The inflatable article according to claim 15, wherein the content of extender oil is greater than 5 phr.

21. The inflatable article according to claim 20, wherein the content of extender oil is between 5 and 100 phr.

22. The inflatable article according to claim 1, wherein the airtight elastomer layer comprises a platy filler.

23. The inflatable article according to claim 1, wherein the elastomer layer has a thickness greater than 0.05 mm.

24. The inflatable article according to claim 23, wherein the elastomer layer has a thickness between 0.1 and 10 mm.

25. The inflatable article according to claim 1, wherein the elastomer layer is placed on the inner wall of the inflatable article.

26. The inflatable article according to claim 1, wherein said inflatable article is a pneumatic tire.

27. The inflatable article according to claim 1, wherein said inflatable article is an inner tube.
